(19) United States
(12) Patent Application Publication
(10) Pub. No.: US 2024/0209846 A1
(43) Pub. Date: Jun. 27, 2024

(54) COMPRESSOR AND MANUFACTURING METHOD THEREFOR

(71) Applicant: GUANGZHOU DESHAN CNC TECHNOLOGY CO., LTD., Guangzhou, Guangdong (CN)

(72) Inventor: Yingxue Luo, Guangzhou, Guangdong (CN)

(21) Appl. No.: 18/562,446

(22) PCT Filed: Feb. 22, 2022
(86) PCT No.: PCT/CN2022/077322

§ 371 Date: Nov. 20, 2023

(30) Foreign Application Priority Data
Aug. 30, 2021 (CN) 202111002997.0

(51) Int. Cl. F04B 39/12; F04B 39/00

(52) U.S. Cl. CPC F04B 39/122; F04B 39/0005; F04B 39/0094

(57) ABSTRACT

A compressor includes: a base including an outer cylinder portion and an inner cylinder portion coaxially disposed, and a bottom wall, where the outer cylinder portion, the inner cylinder portion and the bottom wall are integrally formed, and an assembly space is formed between the outer cylinder portion and the inner cylinder portion; a crankshaft, extending through the inner cylinder portion along an axial direction of the inner cylinder portion; a stator disposed on an inner wall of the outer cylinder portion; a rotor, connected to the crankshaft, where the stator is arranged around the rotor, and both the stator and the rotor are located in the assembly space; a cylinder disposed below the bottom wall; a piston disposed in the cylinder, where the piston is connected to the crankshaft; and a lower bearing disposed below the cylinder, where the lower bearing is connected to the crankshaft.

### TECHNICAL FIELD

The present disclosure relates to the field of heat exchange systems, and in particular, to a compressor and a manufacturing method therefor.

### BACKGROUND

The assembly steps for a traditional rotor compressor are approximately as follows: aligning and pre-assembling components comprising an upper bearing, a cylinder, a piston, a lower bearing and a crankshaft first, and then assembling an outer diameter of the upper bearing with an inner diameter of a housing, so that a stator in the housing is arranged around a rotor disposed on the crankshaft, and after a gap between the stator and the rotor is adjusted by a gap gauge, the stator and the rotor are connected by spot welding.

The aforementioned compressor production method has the following drawbacks. Due to the fact that the main housing is formed by rolling a steel plate, the shape tolerance of the main housing cannot be well guaranteed. In an operation process of the compressor, the gap between the stator and the rotor is extremely prone to being uneven, resulting in electromagnetic noises. In addition, the strength of spot welding connection between the housing and the upper bearing is insufficient, which can easily lead to accident that the upper bearing is separated from the housing.

### SUMMARY

The present disclosure aims to solve at least one of the technical problems in the existing technology. To this end, the present disclosure provides a compressor, which can decrease electromagnetic noises during operation of the compressor, and increase the structural stability of the compressor.

The compressor of the present disclosure comprises: a base comprising an outer cylinder portion and an inner cylinder portion coaxially disposed, and further comprises a bottom wall. The outer cylinder portion and the inner cylinder portion are connected by means of the bottom wall, an axial direction of the outer cylinder portion is along a vertical direction, the outer cylinder portion, the inner cylinder portion and the bottom wall are integrally formed, and an assembly space is formed between the outer cylinder portion and the inner cylinder portion; a crankshaft extending through the inner cylinder portion along an axial direction of the inner cylinder portion; a stator disposed on an inner wall of the outer cylinder portion; a rotor connected to the crankshaft, where the stator is arranged around the rotor, and both the stator and the rotor are located in the assembly space; a cylinder disposed below the bottom wall; a piston disposed in the cylinder, where the piston is connected to the crankshaft; and a lower bearing disposed below the cylinder, where the lower bearing is connected to the crankshaft.

According to some embodiments of the present disclosure, the bottom wall is provided with a waist-shaped hole, and the waist-shaped hole extends through the bottom wall in the vertical direction.

According to some embodiments of the present disclosure, the compressor further comprises an upper cover, and the upper cover is buckled with an upper end of the outer cylinder portion.

According to some embodiments of the present disclosure, an outer side of the upper end of the outer cylinder portion is provided with a stopper portion, and the upper cover is fitted with the stopper portion.

According to some embodiments of the present disclosure, the compressor further comprises a lower cover, and the lower cover is buckled with a lower end of the outer cylinder portion; and a side wall of the lower cover is provided with an air inlet portion.

According to some embodiments of the present disclosure, an outer side of the lower end of the outer cylinder portion is provided with a stopper portion, and the lower cover is in clearance fit with the stopper portion.

According to some embodiments of the present disclosure, the compressor further comprises a pipe joint, and the pipe joint passes through the air inlet portion and communicates with an air inlet side of the cylinder.

According to some embodiments of the present disclosure, a side wall of the pipe joint is provided with a first flange and a second flange, the first flange is engaged with the air inlet portion, and the second flange is engaged with the cylinder.

The present disclosure also provides a compressor manufacturing method for manufacturing the compressor above, comprising: a preparation step: manufacturing the base; a pre-assembly step: pre-assembling the cylinder, the piston, the crankshaft and the lower bearing on the base; a stator mounting step: mounting the stator on an inner wall of the outer cylinder portion; and a rotor mounting step: mounting the rotor on the crankshaft and performing alignment, and then fastening the lower bearing.

According to some embodiments of the present disclosure, a housing mounting step, a pipe joint mounting step and a welding step are sequentially performed after the rotor mounting step; the housing mounting step comprises: covering an upper cover on a stopper portion at an upper end of the outer cylinder portion and covering a lower cover on a stopper portion at a lower end of the outer cylinder portion; the pipe joint mounting step comprises: inserting a pipe joint into an air inlet portion of the low cover and butting with an air inlet side of the cylinder; and the welding step comprises: welding the upper cover with the base, and welding the lower cover with the base.

According to some embodiments of the present disclosure, the upper cover and the lower cover are manufactured by a stamping process.

According to some embodiments of the present disclosure, in the pipe joint mounting step, a first flange is engaged with the air inlet portion, and a second flange is engaged with the cylinder.

According to some embodiments of the present disclosure, in the welding step, a three-segment body formed by connecting the upper cover, the base and the lower cover is welded by laser.

According to some embodiments of the present disclosure, in the preparation step, the base is manufactured by a stamping process.

According to some embodiments of the present disclosure, in the preparation step, a blank of the base obtained by stamping is subjected to rough machining, and the rough machining sequentially comprises: after an upper end face of the blank is leveled, lathing the stopper portions from the upper end and the low end of the outer cylinder portion respectively; finely reaming a stator mounting position on the inner wall of the outer cylinder portion by adopting a reaming process; and leveling an upper end face of the inner cylinder portion, and chamfering an end face of a shaft hole for mounting the crankshaft.

According to some embodiments of the present disclosure, in the preparation step, the blank after the rough machining is subjected to finishing, and the finishing sequentially comprises: taking the finely reamed stator mounting position as a positioning and clamping benchmark to carry out internal expansion self-centering; finely boring a shaft hole of the inner cylinder portion and finely grinding a lower end face of the bottom wall; and honing the shaft hole of the inner cylinder portion by a floating reaming honing process.

According to some embodiments of the present disclosure, a mounting hole and a semi-circular hole opened on the bottom wall are obtained by a stamping process.

In the production process of the compressor according to the present disclosure, the cylinder, the piston, the crankshaft, and the lower bearing may be pre-installed on the base first, then the stator is installed on the inner wall of the outer cylinder portion, and the rotor is installed on the crankshaft, and then the stator and the rotor are aligned. Because the base is an integrally formed part, a tolerance between the inner cylinder portion and the outer cylinder portion can be well controlled in the manufacturing process, and the stator is uniformly stressed after being installed on the inner wall of the outer cylinder portion with little deformation. The stator and the rotor have high coaxiality and uniform gap, which effectively reduces the electromagnetic noises caused by the uneven gap between the stator and the rotor. At the same time, the stator, the rotor, and the cylinder are all disposed on the base. Compared with the existing technology, both the stator and the rotor are supported by the base, which effectively improves the structural stability of the compressor.

Additional aspects and advantages of the present disclosure will be given in part in the following description, and will become apparent in part from the following description, or will be learned through the practice of the present disclosure.

### BRIEF DESCRIPTION OF THE DRAWINGS

The above and/or additional aspects and advantages of the present disclosure will be more apparent from the following description of the embodiments in conjunction with the accompanying drawings, wherein:

FIG. 1 is a front view of a compressor in the embodiments of the present disclosure;

FIG. 2 is a cross-sectional view of the compressor in the embodiments of the present disclosure;

FIG. 3 is a sectional view of a base in FIG. 2;

FIG. 4 is an axial view of the base in FIG. 3;

FIG. 5 is an axial view of the base in FIG. 3 from another perspective;

FIG. 6 is a cross-sectional view of a lower cover in FIG. 2;

FIG. 7 is an axial view of a lower cover in FIG. 3;

FIG. 8 is a cross-sectional view of a pipe joint in FIG. 2; and

The above drawings contain the following reference numerals.

| Reference | |
|---|---|
| numeral | Name |
| 100 | Base |
| 101 | Connecting terminal |
| 102 | Exhaust pipe |
| 103 | Stator |
| 104 | Rotor |
| 105 | Crankshaft |
| 106 | Cylinder |
| 107 | Piston |
| 108 | Lower bearing |
| 111 | Outer cylinder portion |
| 112 | Inner cylinder portion |
| 113 | Bottom wall |
| 114 | Waist-shaped hole |
| 115 | Exhaust duct |
| 200 | Upper cover |
| 300 | Lower cover |
| 310 | Air inlet portion |
| 311 | Flared part |
| 312 | Lug boss |
| 400 | Pipe joint |
| 401 | First flange |
| 402 | Second flange |

### DETAILED DESCRIPTION

The embodiments of the present disclosure will be described in detail hereinafter. Examples of the embodiments are shown in the drawings. The same or similar reference numerals throughout the drawings denote the same or similar elements or elements having the same or similar functions. The embodiments described below by reference to the drawings are exemplary and are intended only to explain the present disclosure and are not to be construed as limiting the present disclosure.

In the description of the present disclosure, it should be understood that the orientation or positional relationship indicated by the terms upper, lower, front, back, left and right is based on the orientation or positional relationship shown in the drawings, only for the convenience of describing the present disclosure and simplifying the description, and does not indicate or imply that the indicated device or element must have a specific orientation, or be constructed and operated in a specific orientation. Therefore, the terms should not be construed as limiting the present disclosure.

In the description of the present disclosure, the meaning of several refers to one or more, and the meaning of multiple refers to be two or more. The meanings of greater than, less than, more than, etc., are understood as not including the following number, while the meanings of above, below, within, etc., are understood as including the following number. If first and second are described, the descriptions are used for the purpose of distinguishing the technical features only, and cannot be understood as indicating or implying relative importance, or implicitly indicating the number of technical features indicated thereby, or implicitly indicating the order of technical features indicated thereby.

In the description of the present disclosure, unless otherwise explicitly defined, words such as setting, mounting and connecting should be understood in a broad sense, and those having ordinary skills in the art can reasonably determine the specific meanings of the above words in the present disclosure in combination with the specific contents of the technical solutions.

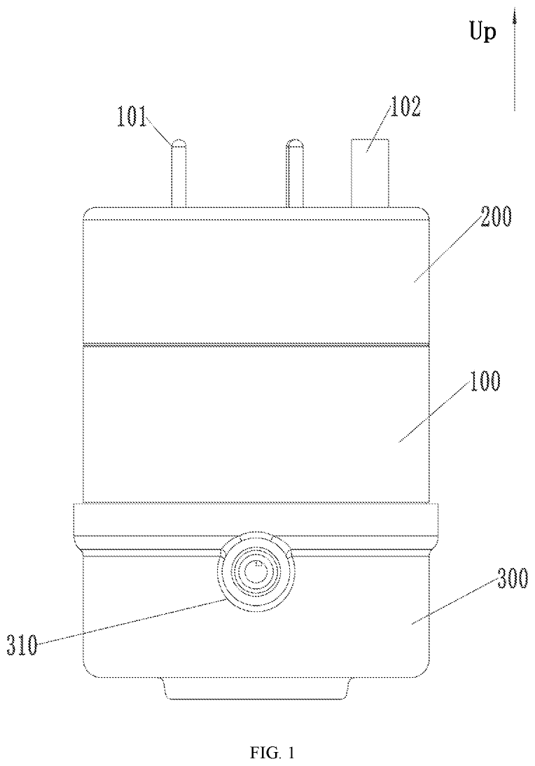

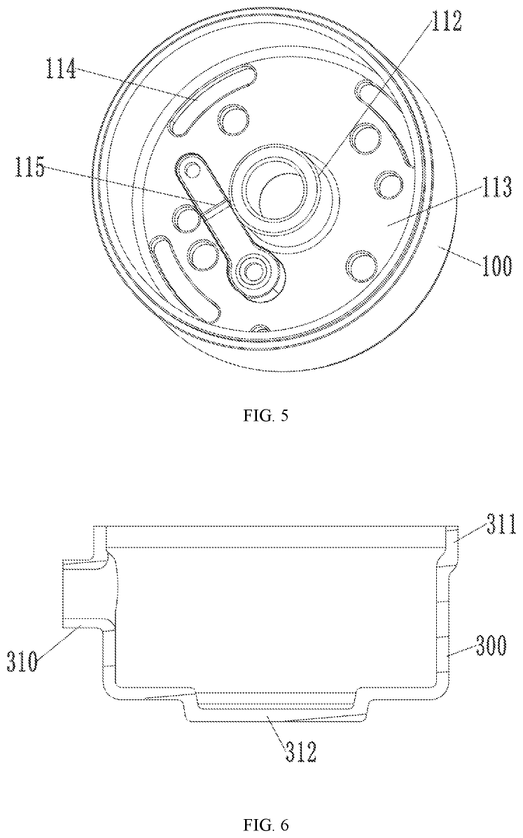

Referring to FIG. 1 to FIG. 8, a compressor according to an embodiment in a first aspect comprises: a base 100 comprising an outer cylinder portion 111 and an inner cylinder portion 112 coaxially disposed, and further comprises a bottom wall 113. The outer cylinder portion 111 and the inner cylinder portion 112 are connected by means of the bottom wall 113, an axial direction of the outer cylinder portion 111 is along a vertical direction, the outer cylinder portion 111, the inner cylinder portion 112 and the bottom wall 113 are integrally formed, and an assembly space is formed between the outer cylinder portion 111 and the inner cylinder portion 112. A crankshaft 105 extends through the inner cylinder portion 112 along an axial direction of the inner cylinder portion 112. A stator 103 is disposed on an inner wall of the outer cylinder portion 111. A rotor 104 is coaxially connected to the crankshaft 105, both the stator 103 and the rotor 104 are located in the assembly space, and the stator 103 is arranged around the rotor 104. A cylinder 106 is disposed below the bottom wall 113. A piston 107 is disposed in the cylinder 106, and the piston 107 is connected to the crankshaft 105. A lower bearing 108 is disposed below the cylinder 106, and the lower bearing 108 is connected to the crankshaft 105.

In the production process of the compressor according to the present disclosure, the cylinder 106, the piston 107, the crankshaft 105, the lower bearing 108 may be pre-installed on the base 100 first, then the stator 103 is installed on the inner wall of the outer cylinder portion 111, and the rotor 104 is installed on the crankshaft 105, and then the stator 103 and the rotor 104 are aligned. Because the base 100 is an integrally formed part, a tolerance between the inner cylinder 112 and the outer cylinder 111 can be well controlled in the manufacturing process, and the stator 103 is uniformly stressed after being installed on the inner wall of the outer cylinder portion 111 with little deformation. The stator 103 and the rotor 104 have high coaxiality and uniform gap, which effectively reduces the electromagnetic noises caused by the uneven gap between the stator 103 and the rotor 104. At the same time, the stator 103, the rotor 104, the cylinder 106 are all disposed on the base 100. Compared with the existing technology, both the stator 103 and the rotor 104 are supported by the base 100, which effectively improves the structural stability of the compressor.

The base 100 can be integrally formed in various ways, for example, the base 100 can be processed by stamping, cold extrusion, and the like, and the base 100 may also be processed by cutting a blank, such as milling and turning.

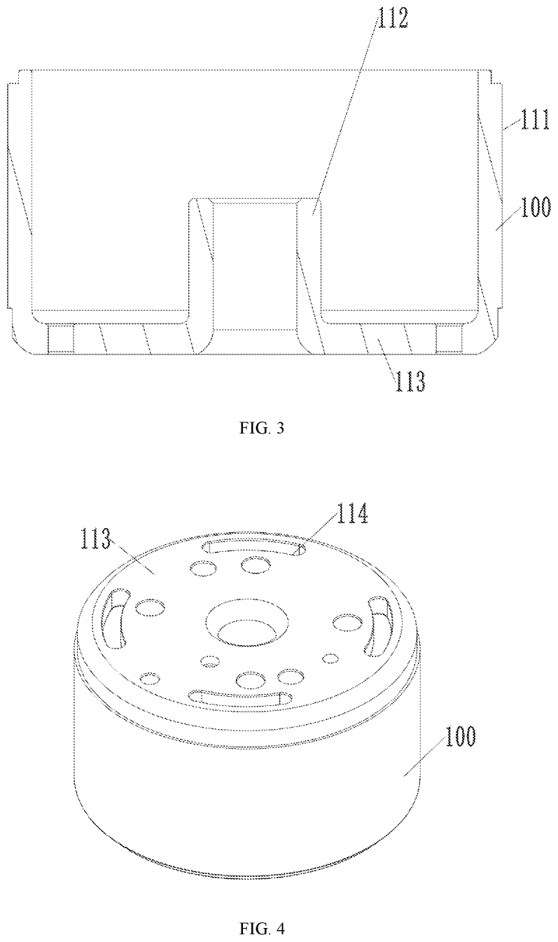

Specifically, as shown in FIG. 3, a cross-sectional shape of the base 100 is similar to a letter E, and the base comprises the inner cylinder portion 112 and the outer cylinder portion 111 which are coaxially disposed. The inner wall of the outer cylinder portion 111 is provided with a stator 103 mounting position for mounting the stator 103, and the inner cylinder has a shaft hole extending across the inner cylinder vertically for mounting the crankshaft 105. The outer cylinder portion 111 also serves as a housing, while the inner cylinder portion 112 serves the upper bearing for the compressor, that is, the base 100 may be regarded as a component after the upper bearing and a part of the housing are integrated.

On the base 100, installation methods of the stator 103, the rotor 104, the crankshaft 105, the cylinder 106, the piston 107 and the lower bearing 108 may all refer to the structure of the existing rotor 104 compressor. A plurality of bolts pass through the base 100, the cylinder 106 and the lower bearing 108 and fix these parts. In this case, the upper and lower bearings 108 jointly serve to support the crankshaft 105.

As shown in FIG. 4, the bottom wall 113 is provided with a waist-shaped hole 114, and the waist-shaped hole 114 extends through the bottom wall 113 in the vertical direction. The waist-shaped hole 114 has ventilation function and flexible buffering function, which reduces the external impact on a pump caused by thermal deformation of the housing and improves the operation reliability of the compressor. When the base 100 is manufactured by using a stamping process, slot holes such as the waist-shaped hole 114 and a bolt fixing hole formed on the bottom wall 113 can be punched out through the stamping process, thus improving the production efficiency.

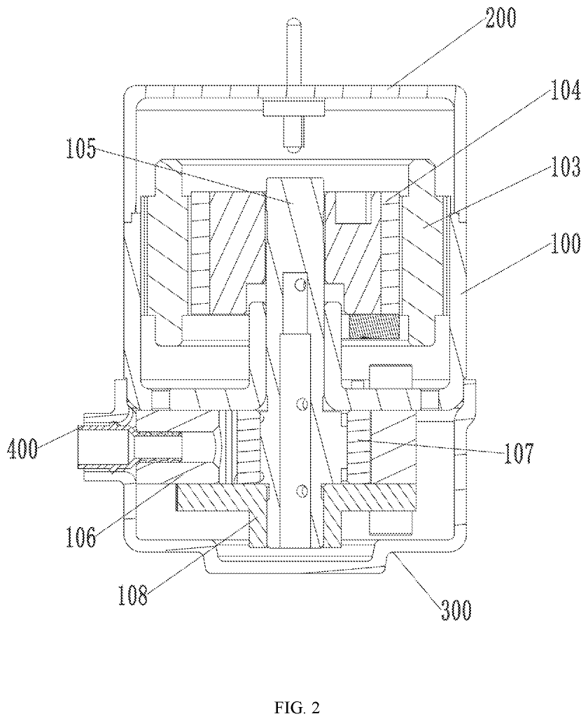

As shown in FIG. 2, the compressor further comprises an upper cover 200, and the upper cover 200 is buckled with an upper end of the outer cylinder portion 111; wherein, the outer cylinder portion 111 and the upper cover 200 together serve as a part of the whole housing of the compressor. An exhaust pipe 102 and a connecting terminal 101 are also disposed on the housing. The exhaust pipe 102 is used for discharging a refrigerant compressed by the compressor, and the connecting terminal 101 is used for supplying power to a motor and controlling an operation of the motor.

As shown in FIG. 3, an outer side of the upper end of the outer cylinder portion 111 is provided with a stopper portion, and the upper cover 200 is fitted with the stopper portion. When the upper cover 200 is covered on the outer cylinder portion 111, the stopper portion on the outer side of the upper end of the outer cylinder portion 111 can serves to limit the upper cover 200, allowing for accurate mounting between the upper cover 200 and the base 100, and a position of the upper cover 200 covered on the stopper portion can be finely adjusted before welding the two.

As shown in FIG. 2 and FIG. 6, the compressor further comprises a lower cover 300, and the lower cover 300 is buckled with a lower end of the outer cylinder portion 111; and a side wall of the lower cover 300 is provided with an air inlet portion 310; wherein, the upper cover 200, the outer cylinder portion 111 of the base 100 and the lower cover 300 are respectively served as three segments of the housing of the compressor, and the air inlet portion 310 is used for butting the air inlet side of the cylinder 106 with an air inlet copper pipe.

As shown in FIG. 3, an outer side of the lower end of the outer cylinder portion 111 is provided with a stopper portion, and the lower cover 300 is in clearance fit with the stopper portion. When the upper cover 200 is covered on the outer cylinder portion 111, the stopper portion on the outer side of the lower end of the outer cylinder portion 111 can serve to limit the lower cover 300, allowing for accurate mounting between the lower cover 300 and the base 100, and a position of the lower cover 300 covered on the stopper portion can be finely adjusted before completely welding the two.

Specifically, due to the clearance fit between the lower cover 300 and the stopper portion, in the compressor assembly process, the lower cover 300 may be installed on the base 100 first, and then the pipe joint 400 may be installed, and then the lower cover 300 may be welded with the base 100 after the pipe joint 400 is installed in place and aligned with the air inlet side of the cylinder 106. Due to the interference fit between the pipe joint 400 and the air inlet portion 310, the above mounting method can ensure that the pipe joint 400 is aligned with the air inlet side of the cylinder 106 and prevent air leakage.

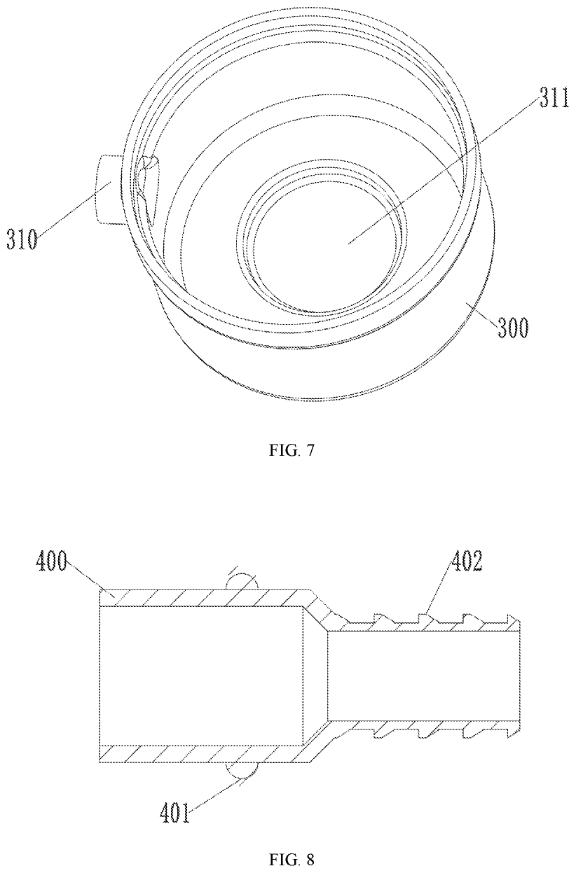

Specifically, as shown in FIG. 6 and FIG. 7, a bottom portion of the lower cover 300 is further provided with a lug boss 312, which may be used for positioning and installing a compressor damping device, while a top portion of the lower cover 300 is provided with a flared portion 311, and the flared portion 311 is in clearance fit with the stopper portion at the outer side of the lower end of the outer cylinder portion 111.

In this embodiment, the upper cover 200, the lower cover 300 and the base 100 can all be manufactured by a stamping process, and the air inlet portion 310 formed on the lower cover 300 can be manufactured by a side drawing process, so that the production efficiency can be effectively improved while the accuracy of components is ensured.

As shown in FIG. 2, the compressor further comprises a pipe joint 400, and the pipe joint 400 passes through the air inlet portion 310 and communicates with an air inlet side of the cylinder 106. The pipe joint 400 is used to connect a copper pipe in a refrigerant system with the air inlet side of the cylinder 106.

Specifically, as shown in FIG. 8, a side wall of the pipe joint 400 is provided with a first flange 401 and a second flange 402, the first flange 401 is engaged with the air inlet portion 310, and the second flange 402 is engaged with the cylinder 106. The first flange 401 has a circular cross section, which is used to be engaged with the air inlet portion 310 to prevent foreign matters from entering the compressor during final welding. The second flange 402 has a stepped section and has a barb structure, which can ensure the sealing of an assembly surface after mounting and avoid high-low pressure air leakage at a suction hole of the compressor. A detailed structure of the pipe joint 400 may refer to the existing technology such as CN108644502A.

A compressor manufacturing method according to an embodiment in a second aspect for manufacturing the compressor above, comprises: a preparation step: manufacturing the base 100; a pre-assembly step: pre-assembling the cylinder 106, the piston 107, the crankshaft 105 and the lower bearing 108 on the base 100; a stator 103 mounting step: mounting the stator 103 on the inner wall of the outer cylinder portion 111; and a rotor 104 mounting step: mounting the rotor 104 on the crankshaft 105 and performing alignment, and then fastening the lower bearing 108.

Because the base 100 is an integral part and the base 100 provides support for the stator 103 and the rotor 104 at the same time, the lower bearing 108 is not fastened at first in the pre-assembly step, but after the stator 103 and the rotor 104 are aligned, the lower bearing 108 is fastened, the gap between the stator 103 and the rotor 104 is uniform and the operation is stable, which effectively reduces electromagnetic noises caused by the uneven gap between the stator 103 and the rotor 104.

Specifically, as shown in FIG. 2, a housing mounting step, a pipe joint 400 mounting step and a welding step are sequentially performed after the rotor 104 mounting step; the housing mounting step comprises: covering the upper cover 200 on the stopper portion at the upper end of the outer cylinder portion 111 and covering the lower cover 300 on the stopper portion at the lower end of the outer cylinder portion 111; the pipe joint 400 mounting step comprises: inserting the pipe joint 400 into the air inlet portion 310 of the low cover 300 and butting with the air inlet side of the cylinder 106; and the welding step comprises: welding the upper cover 200 with the base 100, and welding the lower cover 300 with the base 100. Due to the clearance fit between the flared portion 311 and the stopper portion, in the compressor assembly process, the flared portion 311 may be installed on the base 100 first, and then the pipe joint 400 may be installed, and then the lower cover 300 may be welded with the base 100 after the pipe joint 400 is installed in place and aligned with the air inlet side of the cylinder 106. Due to the interference fit between the pipe joint 400 and the air inlet portion 310, the above mounting method can ensure that the pipe joint 400 is aligned with the air inlet side of the cylinder 106 and prevent air leakage.

Specifically, in the pipe joint 400 mounting step, the first flange 401 is engaged with the air inlet portion 310, and the second flange 402 is engaged with the cylinder 106. The first flange 401 has a circular cross section, which is used to be engaged with the air inlet portion 310 to prevent foreign matters from entering the compressor during final welding. The second flange 402 has a stepped section and has a barb structure, which can ensure the sealing of an assembly surface after mounting and avoid high-low pressure air leakage at a suction hole of the compressor.

As shown in FIG. 2, in the final welding step, a three-segment body formed by connecting the upper cover 200, the base 100 and the lower cover 300 is welded by laser. In this case, the upper cover 200, the outer cylinder portion 111 and the lower cover 300 together constitute a housing portion of the whole compressor, and the whole compressor has a stable structure, a reasonable bearing structure, a uniform gap between the stator 103 and the rotor 104, and low operation noise.

As shown in FIG. 3, in the preparation step, the base 100 may be manufactured by a stamping process to improve the production efficiency. Specifically, a plate material with a brand of SPCC-2D and a thickness of 3.2 mm may be selected during stamping, and a blanking weight is 264 g; a weight of a punched product is 117 g. When meeting the strength requirements of the base 100, the punched product is lighter in weight. Meanwhile, compared with the upper bearing component made of HT250 material in the existing technology, the weight is effectively reduced while a bearing capacity requirement is met.

Specifically, in the preparation step, it is also necessary to carry out rough machining on a blank obtained by stamping, wherein the rough machining comprises the following steps in sequence: after an upper end face of the blank is leveled, lathing the stopper portion from the upper end and the low end of the outer cylinder portion 111 respectively; finely reaming a stator 103 mounting position on the inner wall of the outer cylinder portion 111 by adopting a reaming process to ensure that cylindricity of the stator 103 mounting position is less than 0.02; and leveling an upper end face of the inner cylinder portion 112, and chamfering an end face of a shaft hole for mounting the crankshaft 105. In the whole rough machining step, a central shaft hole in the inner cylinder portion 112 of the stamped blank is taken as a positioning reference for mechanical rough machining.

In the preparation step, the blank after the rough machining also needs to be subjected to finishing, and the finishing sequentially comprises the following steps of: taking the finely reamed stator 103 mounting position as a positioning and clamping benchmark to carry out internal expansion self-centering; finely boring a shaft hole of the inner cylinder portion 112 and finely grinding a lower end face of the bottom wall 113; and honing the shaft hole of the inner cylinder portion 112 by a floating reaming honing process. The machining of the end face and the inner hole is completed through the same clamping, so as to ensure that verticality between the shaft hole and the end face is less than 0.002, and coaxiality between the shaft hole of the inner cylinder portion 112 and the stator 103 mounting position is less than 0.03.

In the process of manufacturing the base 100 by the stamping process, the structures such as the mounting hole, the semi-circular hole and an exhaust duct 115 formed in the bottom wall 113 can be formed by the stamping process.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure.

1. A compressor, comprising:
a base comprising an outer cylinder portion and an inner cylinder portion coaxially disposed, and further comprising a bottom wall, wherein the outer cylinder portion and the inner cylinder portion are connected by means of the bottom wall, an axial direction of the outer cylinder portion is along a vertical direction, the outer cylinder portion, the inner cylinder portion and the bottom wall are integrally formed, and an assembly space is formed between the outer cylinder portion and the inner cylinder portion;
a crankshaft extending through the inner cylinder portion along an axial direction of the inner cylinder portion;
a stator disposed on an inner wall of the outer cylinder portion;
a rotor connected to the crankshaft coaxially, wherein the stator is arranged around the rotor, and both the stator and the rotor are located in the assembly space;
a cylinder disposed below the bottom wall;
a piston disposed in the cylinder, wherein the piston is connected to the crankshaft; and
a lower bearing disposed below the cylinder, wherein the lower bearing is connected to the crankshaft.

2. The compressor according to claim 1, wherein the bottom wall is provided with a waist-shaped hole, and the waist-shaped hole extends through the bottom wall in the vertical direction.

3. The compressor according to claim 1, further comprising an upper cover, wherein the upper cover is buckled with an upper end of the outer cylinder portion.

4. The compressor according to claim 3, wherein an outer side of the upper end of the outer cylinder portion is provided with a stopper portion, and the upper cover is fitted with the stopper portion.

5. The compressor according to claim 1, further comprising a lower cover, wherein the lower cover is buckled with a lower end of the outer cylinder portion; and a side wall of the lower cover is provided with an air inlet portion.

6. The compressor according to claim 5, wherein an outer side of the lower end of the outer cylinder portion is provided with a stopper portion, and the lower cover is in clearance fit with the stopper portion.

7. The compressor according to claim 5, further comprising a pipe joint, wherein the pipe joint passes through the air inlet portion and communicates with an air inlet side of the cylinder.

8. The compressor according to claim 7, wherein a side wall of the pipe joint is provided with a first flange and a second flange, the first flange is engaged with the air inlet portion, and the second flange is engaged with the cylinder.

9. A compressor manufacturing method for manufacturing the compressor according to claim 1, comprising:
a preparation step: manufacturing the base;
a pre-assembly step: pre-assembling the cylinder, the piston, the crankshaft and the lower bearing on the base;
a stator mounting step: mounting the stator on an inner wall of the outer cylinder portion; and
a rotor mounting step: mounting the rotor on the crankshaft and performing alignment, and then fastening the lower bearing.

10. The compressor manufacturing method according to claim 9, wherein a housing mounting step, a pipe joint mounting step and a welding step are sequentially performed after the rotor mounting step;
the housing mounting step comprises: covering an upper cover on a stopper portion at an upper end of the outer cylinder portion and covering a lower cover on the stopper portion at a lower end of the outer cylinder portion;
the pipe joint mounting step comprises: inserting a pipe joint into an air inlet portion of the low cover and butting with an air inlet side of the cylinder; and
the welding step comprises: welding the upper cover with the base, and welding the lower cover with the base.

11. The compressor manufacturing method according to claim 10, wherein the upper cover and the lower cover are manufactured by a stamping process.

12. The compressor manufacturing method according to claim 10, wherein in the pipe joint mounting step, a first flange is engaged with the air inlet portion, and a second flange is engaged with the cylinder.

13. The compressor manufacturing method according to claim 10, wherein in the welding step, a three-segment body formed by connecting the upper cover, the base and the lower cover is welded by laser.

14. The compressor manufacturing method according to claim 10, wherein in the preparation step, the base is manufactured by a stamping process.

15. The compressor manufacturing method according to claim 14, wherein in the preparation step, a blank of the base obtained by stamping is subjected to rough machining, and the rough machining sequentially comprises:
after an upper end face of the blank is leveled, lathing the stopper portions from the upper end and the low end of the outer cylinder portion respectively;
finely reaming a stator mounting position on the inner wall of the outer cylinder portion by adopting a reaming process; and
leveling an upper end face of the inner cylinder portion, and chamfering an end face of a shaft hole for mounting the crankshaft.

16. The compressor manufacturing method according to claim 15, wherein in the preparation step, the blank after the rough machining is subjected to finishing, and the finishing sequentially comprises:
taking the finely reamed stator mounting position as a positioning and clamping benchmark to carry out internal expansion self-centering;
finely boring a shaft hole of the inner cylinder portion and finely grinding a lower end face of the bottom wall; and
honing the shaft hole of the inner cylinder portion by a floating reaming honing process.

17. The compressor manufacturing method according to claim 14, wherein a mounting hole and a semi-circular hole opened on the bottom wall are obtained by a stamping process.
